(19) United States
(12) Patent Application Publication
(10) Pub. No.: US 2025/0239587 A1
(43) Pub. Date: Jul. 24, 2025

(54) CATHODE ELECTRODES INCLUDING MULTIPLE PARTICLE SIZE DISTRIBUTIONS MANUFACTURED USING A SOLVENT-FREE PROCESS

(71) Applicant: GM GLOBAL TECHNOLOGY OPERATIONS LLC, Detroit, MI (US)

(72) Inventors: Yong Lu, Shanghai (CN); Meiyuan Wu, Shanghai (CN); Haijing Liu, Shanghai (CN)

(21) Appl. No.: 18/591,591

(22) Filed: Feb. 29, 2024

(30) Foreign Application Priority Data
Jan. 18, 2024 (CN) 202410076681.3

(51) Int. Cl. H01M 4/13; H01M 4/02; H01M 4/04; H01M 4/62

(52) U.S. Cl. CPC H01M 4/13; H01M 4/0435; H01M 2004/021; H01M 2004/028; H01M 4/623

(57) ABSTRACT

A cathode electrode for a battery cell includes a cathode current collector and a cathode active material layer arranged on the cathode current collector. The cathode active material layer comprises a first cathode active material having a first secondary particle size distribution, a second cathode active material having a second secondary particle size distribution different than the first secondary particle size distribution, a conductive additive, and a fibrillating binder.

### CROSS-REFERENCE TO RELATED APPLICATIONS

This application claims the benefit of Chinese Patent Application No. 202410076681.3, filed on Jan. 18, 2024. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to cathode electrodes with blended particle sizes for cathode electrodes manufactured using solvent-free process.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators. The cathode electrodes include a cathode active material layer arranged on a cathode current collector. The anode electrodes include an anode active material layer arranged on an anode current collector.

### SUMMARY

A cathode electrode for a battery cell includes a cathode current collector and a cathode active material layer arranged on the cathode current collector. The cathode active material layer comprises a first cathode active material having a first secondary particle size distribution, a second cathode active material having a second secondary particle size distribution different than the first secondary particle size distribution, a conductive additive, and a fibrillating binder.

In other features, the first secondary particle size distribution includes a D50 secondary particle size in a range from 10 μm to 20 μm. The first secondary particle size distribution includes a D90 secondary particle size in a range from 15 μm to 30 μm. The first cathode active material and the second cathode active material comprise secondary particles.

In other features, the first cathode active material comprises secondary particles and the second cathode active material comprises single crystals. The second secondary particle size distribution includes a D50 secondary particle size in a range from 2 μm to 8 μm. The second cathode active material comprises 5 wt % to 40 wt % of cathode active material in the cathode active material layer.

In other features, the cathode active material layer comprises cathode active material in a range from 90 wt % to 96.5 wt %, the conductive additive in a range from 2 wt % to 5 wt %, and the fibrillating binder in a range from 1.5 wt % to 5 wt %. The second active material particles fill spaces between the first active material particles and greater than 90 wt % of the second active material particles are connected to clusters including the fibrillating binder and the conductive additive.

In other features, the fibrillating binder comprises polytetrafluoroethylene (PTFE). The cathode active material layer has a D50 particle size in a range from 6 μm to 16 μm, a D90 particle size in a range from 20 μm to 30 μm, and a specific area in a range from 0.6 to 1.3 m²/g.

A method for manufacturing a cathode electrode for a battery cell includes a) creating a mixture by mixing a first cathode active material with a first particle size distribution, a second cathode active material having a second particle size distribution different than the first particle size distribution, and a conductive additive; b) adding a fibrillating binder to the mixture; c) using high shear force on the mixture to fibrillate the fibrillating binder; d) calendaring the mixture to create a cathode active material layer; and e) laminating the cathode active material layer onto a cathode current collector to form a cathode electrode.

In other features, a) comprises a1) mixing the first cathode active material and the second cathode active material; and a2) adding the conductive additive to the first cathode active material and the second cathode active material.

In other features, a) comprises a1) mixing the first cathode active material with the conductive additive; a2) mixing the second cathode active material with the conductive additive; and a3) mixing the first cathode active material with the conductive additive and the second cathode active material with the conductive additive.

In other features, the first secondary particle size distribution includes a D50 particle size in a range from 10 μm to 20 μm. The first secondary particle size distribution includes a D90 particle size in a range from 15 μm to 30 μm. The first cathode active material and the second cathode active material comprise secondary particles.

In other features, the first cathode active material comprises secondary particles and the second cathode active material comprises single crystals.

In other features, the second secondary particle size distribution includes a D50 particle size in a range from 2 μm to 8 μm, and the second secondary particle size distribution includes a D90 particle size in a range from 5 μm to 10 μm.

In other feature, the second cathode active material comprises 5 wt % to 40 wt % of cathode active material in the cathode active material layer.

In other features, the cathode active material layer comprises cathode active material in a range from 90 wt % to 96.5 wt %, the conductive additive in a range from 2 wt % to 5 wt %, and the fibrillating binder in a range from 1.5 wt % to 5 wt %. The cathode active material layer has a D50 particle size in a range from 6 μm to 16 μm, a D90 particle size in a range from 20 μm to 30 μm, and a specific area in a range from 0.6 to 1.3 m²/g.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross section of an example of a battery cell including cathode electrodes, anode electrodes, and separators according to the present disclosure;

FIG. 2 is a side cross section of an example of a cathode electrode according to the present disclosure;

FIGS. 3A to 5B are scanning electron microscope images of examples of various cathode active material layers;

FIGS. 6A and 6B illustrate examples of cathode active material layers including cathode active materials with different particle size distributions according to the present disclosure;

FIGS. 7 to 9 are flowcharts of examples of methods for manufacturing cathode electrodes with different particle size distributions according to the present disclosure;

FIGS. 10A and 10B are scanning electron microscope images of an example a cathode active material layer with large and small secondary particle size distributions according to the present disclosure;

FIG. 11 is a graph showing density distribution percentage as a function of secondary particle size for the example in FIGS. 12A and 12B;

FIGS. 12A and 12B are scanning electron microscope images of an example a cathode active material layer with large secondary particles and small single crystals according to the present disclosure; and

FIG. 13 is a graph showing density distribution percentage as a function of secondary particle size for the example in FIGS. 14A and 14B.

In the drawings, reference numbers may be reused to identify similar and/or identical elements.

### DETAILED DESCRIPTION

While battery cells according to the present disclosure are shown in the context of electric vehicles, the battery cells can be used in stationary applications and/or other applications.

The present disclosure relates to cathode electrodes and methods for manufacturing the cathode electrodes using solvent-free manufacturing processes. The present disclosure relates to binding mechanisms of fibrillating binder-based cathode electrodes and particle size distributions of cathode active materials used in the cathode active material layer.

Cathode active materials with polydisperse particle size distributions are optimal when using solvent-free manufacturing processes. Cathode electrodes described herein use cathode active materials with at least two different blended particle size distributions. More particularly, the cathode active material of the cathode electrodes includes large secondary particles coupled with small secondary particles or single crystals.

The binder is fibrillated to create fibril networks. The combination of the fibril networks and the variation in particle sizes increases the performance of the cathode electrodes (e.g., carbon distribution uniformity and mechanical properties). The large secondary particles coupled with the small secondary particles and/or single crystals can be made using the same type of cathode active material or blends including two or more types of cathode active materials.

Referring now to FIG. 1, a battery cell 10 includes C cathode electrodes 20, A anode electrodes 40, and S separators 32 arranged in a predetermined sequence in a battery cell stack 12, where C, S and A are integers greater than zero. The battery cell stack 12 is arranged in an enclosure 50. The C cathode electrodes 20-1, 20-2, . . . , and 20-C include cathode active material layers 24 arranged on one or both sides of a cathode current collector 26.

The A anode electrodes 40-1, 40-2, . . . , and 40-A include anode active material layers 42 arranged on one or both sides of the anode current collectors 46. In some examples, the cathode active material layers 24 and/or the anode active material layers 42 comprise a mixture of one or more active materials, one or more conductive additives, and/or one or more binder materials that are applied to the current collectors. During charging/discharging, the A anode electrodes 40 and the C cathode electrodes 20 exchange lithium ions.

In some examples, the cathode current collector 26 and/or the anode current collector 46 comprise metal foil, metal mesh, perforated metal, 3 dimensional (3D) metal foam, and/or expanded metal. In some examples, the current collectors are made of one or more materials selected from a group consisting of copper, stainless steel, brass, bronze, zinc, aluminum, and/or alloys thereof. External tabs 28 and 48 are connected to the current collectors of the cathode electrodes and anode electrodes, respectively, and can be arranged on the same or different sides of the battery cell stack 12. The external tabs 28 and 48 are connected to terminals of the battery cells. In some examples, the battery cells are stacked or wound. In some examples, the enclosure includes a prismatic enclosure, a pouch enclosure, or a cylindrical enclosure.

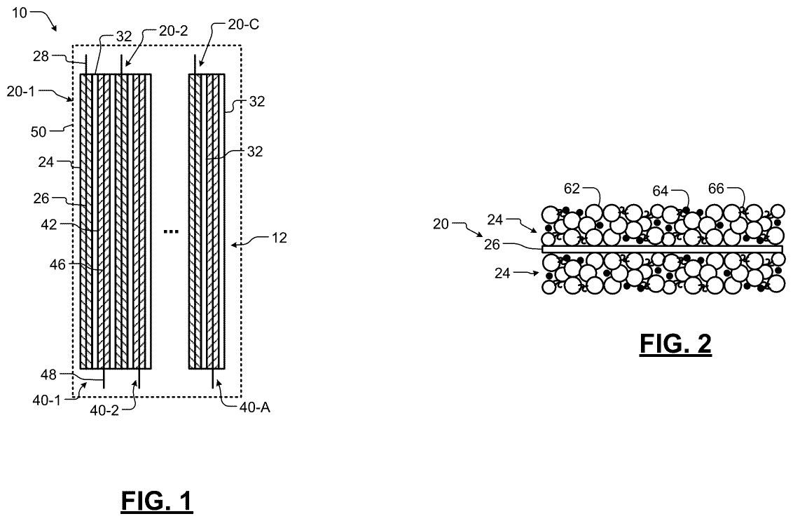

Referring now to FIG. 2, the C cathode electrodes 20 are shown in further detail. The cathode active material layer 24 of the C cathode electrodes 20 includes cathode active material 62, a conductive additive 64, and a binder 66. The large secondary particles and small secondary particles and/or single crystals can include the same cathode active material or two or more types of cathode active materials.

When using a wet process, the binder is homogenous and coats the cathode active material. The binder typically comprises 2 wt % to 5 wt % of the cathode active material layer. The wet process produces cathode electrodes with blocked ionic conduction, blocked electronic conduction, and/or high conductive tortuosity.

When using a dry process, the binder is fibrillated and does not necessarily coat the surface of the cathode active material. The binder typically comprises no higher than 2 wt % of the cathode active material layer. The dry process produces good ionic and electronic conduction and low conductive tortuosity.

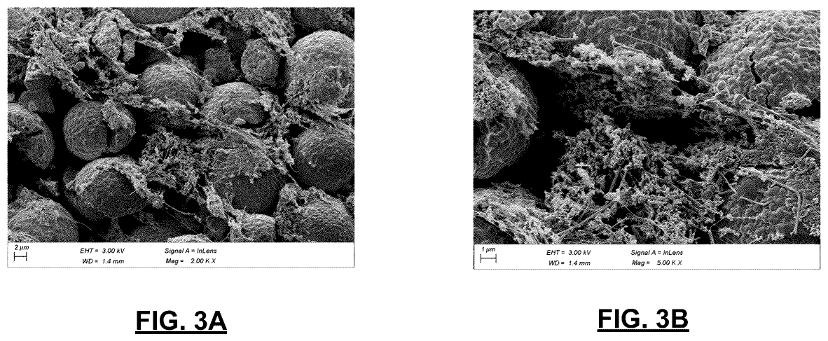

Referring now to FIGS. 3A to 5B, scanning electron microscope images of different types of cathode active material layers are shown. In FIGS. 3A and 3B, the cathode active material layer includes only large secondary particles of the cathode active material. When using large secondary particles, the cathode electrode film is soft due to long fibrils but has poor distribution of the conductive additive.

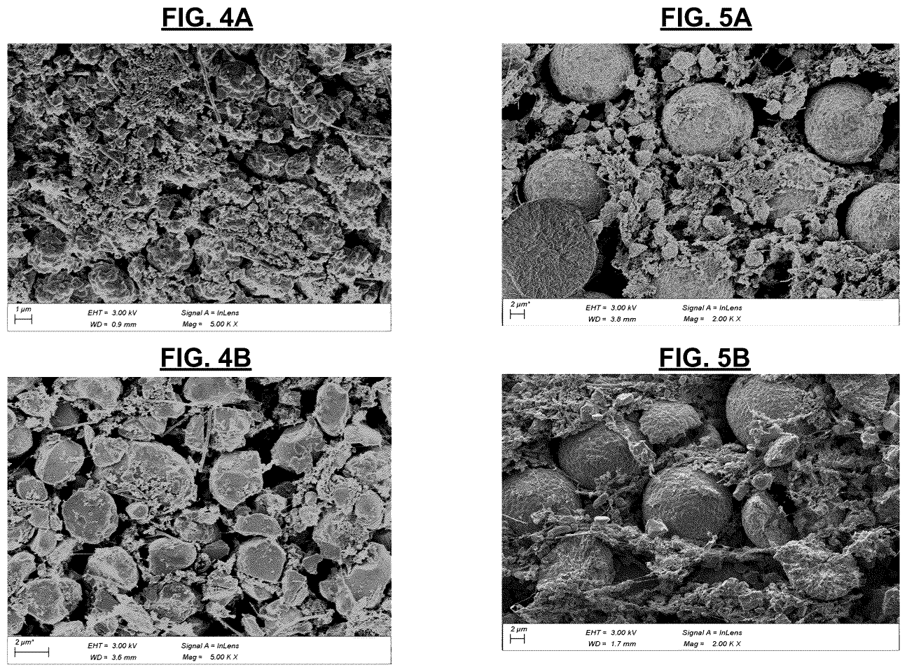

In FIGS. 4A and 4B, the cathode electrodes include only small secondary particles of cathode active material. When using small secondary particles, the cathode electrode film is brittle due to short fibrils and has good distribution of the conductive additive.

In FIGS. 5A and 5B, the cathode electrodes include both large secondary particles and small secondary particles or single-crystal particles of the cathode active material. When bi-modal secondary particles of cathode active material are used, the cathode electrode film has good film processing capability and good distribution of the conductive additive. As can be appreciated from the foregoing, particle size impacts PTFE fibril networks and carbon distribution uniformity.

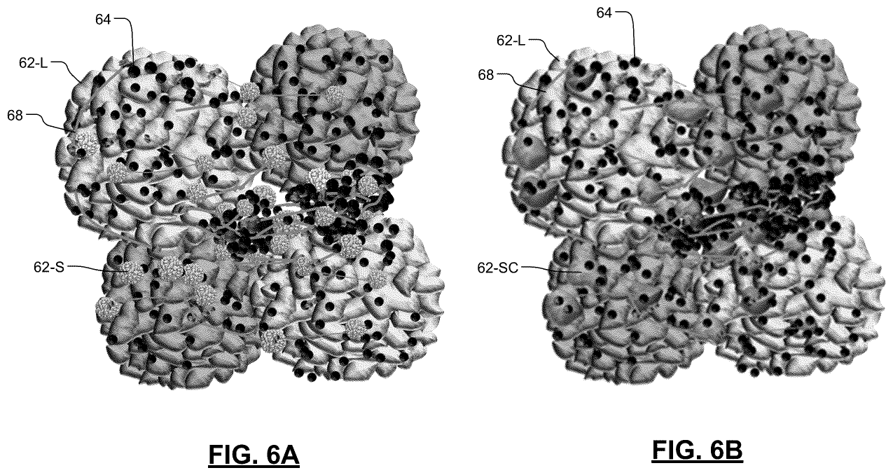

Referring now to FIGS. 6A and 6B, the cathode active material includes N different particle size distributions (where N≥2). The smaller active material particles fill up spaces between larger secondary particles. In some examples, >90 wt % of the smaller active material particles are closely connected with the PTFE/conductive additive clusters to form fibril structures. In FIG. 8A, the larger cathode active material particles include secondary particles and the smaller cathode active materials include smaller secondary particles. In FIG. 8B, the larger cathode active material particles include secondary particles and the smaller cathode active materials include single crystals.

The cathode electrode comprises a first cathode active material (having a first particle size distribution), a second cathode active material (having a second particle size distribution), a conductive additive (e.g., conductive carbon), and PTFE binder. In some examples, a D50 particle size of the first cathode active material is in a range from 10 μm to 20 μm. In some examples, a D90 particle size of the first cathode active material is in a range from 15 μm to 30 μm.

In some examples, the second cathode active material has a second particle size dispersion. The second cathode active material includes at least one of secondary particles and single crystals. In some examples, a D50 particle size of the second cathode active material is in a range from 2 μm to 8 μm. In some examples, a D90 particle size of the second cathode active material is in a range from 5 μm to 10 μm.

In some examples, the second cathode active material comprises 5 wt % to 40 wt % of the cathode active material. In some examples, the dry electrode comprises 90 wt % to 96.5 wt % of the cathode active material, 2 wt % to 5 wt % of the conductive additive, and 1.5 wt % to 5 wt % of the fibrillating binder. The electrode material mixtures (the active material, conductive filler, and binder) have a D50 particle size in a range from 6 μm to 16 μm, a D90 particle size in a range from 20 μm to 30 μm, and a specific area in a range from 0.6 to 1.3 m²/g.

In some examples, the first cathode active material and the second cathode active material include the same cathode active material. In some examples, the first cathode active material and/or the second cathode active material include different cathode active material. In some examples, the first cathode active material includes a blend of cathode active material (or a single type of cathode active material) and the second cathode active material includes a blend of cathode active material (or a single type of cathode active material). In some examples, the first cathode active material includes a first type of cathode active material and the second cathode active material includes a second type of cathode active material.

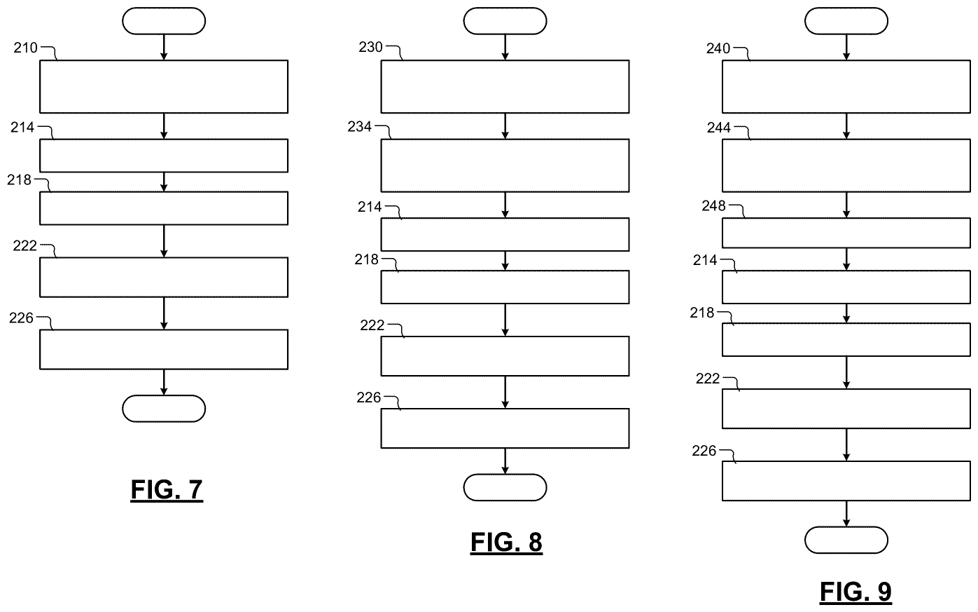

Referring now to FIGS. 7 to 9, various examples of methods for manufacturing cathode electrodes is shown. In FIG. 7, a first cathode active material having a first particle size dispersion, a second cathode active material having a second particle size dispersion, and conductive additive are mixed at 210. At 214, PTFE powder is added. At 218, high shear force fibrillation is performed to fibrillate the binder. At 222, the cathode active materials are calendared (pressed and/or heated one or more times) to form a self-standing cathode active material layer. At 226, the cathode active material layer is laminated onto a cathode current collector.

In FIG. 8, the first cathode active material having a first particle size dispersion and the second cathode active material having a second particle size dispersion are mixed at 230. At 234, conductive additive is added to the mixture and then the method proceeds with steps 214 to 226.

In FIG. 9, the first cathode active material having a first particle size dispersion is mixed with conductive additive at 240. At 244, the second cathode active material having a first secondary particle size dispersion is mixed with conductive additive at 244. At 248, the first and second cathode active materials mixture (including the conductive additive) are mixed and then the method proceeds with steps 214 to 226.

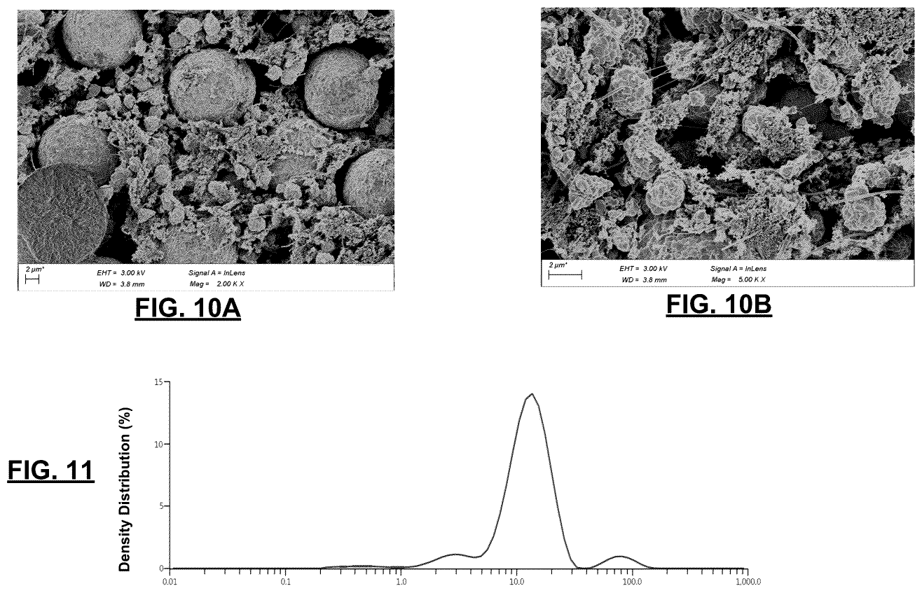

Referring now to FIGS. 10A to 11, an example including cathode active material with larger secondary particles and smaller secondary particles is shown. In this example, the first cathode active material having a first particle size dispersion comprises 80 wt % of the cathode active material. In this example, the second cathode active material having a; second particle size dispersion comprises 20 wt % of the cathode active material. The surface area is 0.789 m²/g. The secondary particle sizes include Dv(0)=0.216 μm, Dv(5)=2.91 μm, Dv(10)=5.94 μm, Dv(50)=12.6 μm, Dv(90)=21.8 μm, and Dv(100)=143 μm.

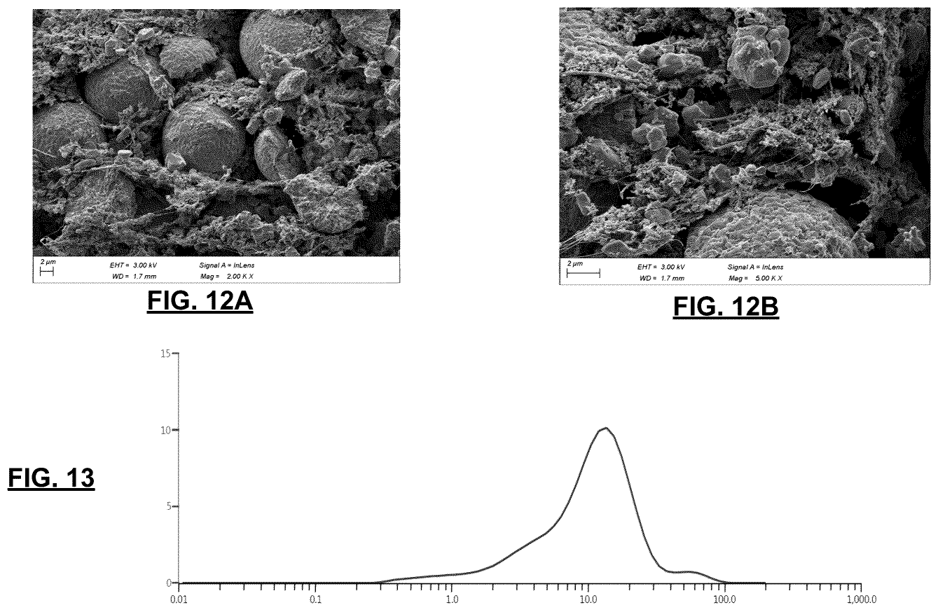

Referring now to FIGS. 12A to 13, an example including cathode active material with larger secondary particles and single crystals is shown. The surface area is 1.06 m²/g. The secondary particle sizes and single crystals include Dv(0)=0.280 μm, Dv(5)=1.73 μm, Dv(10)=2.97 μm, Dv(50)=11.1 μm, Dv(90)=22.9 μm, and Dv(100)=97.6 μm.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A cathode electrode for a battery cell, comprising:
a cathode current collector; and
a cathode active material layer arranged on the cathode current collector,
wherein the cathode active material layer comprises a first cathode active material having a first secondary particle size distribution, a second cathode active material having a second secondary particle size distribution different than the first secondary particle size distribution, a conductive additive, and a fibrillating binder.

2. The cathode electrode of claim 1, wherein the first secondary particle size distribution includes a D50 secondary particle size in a range from 10 μm to 20 μm.

3. The cathode electrode of claim 2, wherein the first secondary particle size distribution includes a D90 secondary particle size in a range from 15 μm to 30 μm.

4. The cathode electrode of claim 1, wherein the first cathode active material and the second cathode active material comprise secondary particles.

5. The cathode electrode of claim 1, wherein the first cathode active material comprises secondary particles and the second cathode active material comprises single crystals.

6. The cathode electrode of claim 2, wherein the second secondary particle size distribution includes a D50 secondary particle size in a range from 2 μm to 8 μm.

7. The cathode electrode of claim 1, wherein the second cathode active material comprises 5 wt % to 40 wt % of cathode active material in the cathode active material layer.

8. The cathode electrode of claim 1, wherein the cathode active material layer comprises cathode active material in a range from 90 wt % to 96.5 wt %, the conductive additive in a range from 2 wt % to 5 wt %, and the fibrillating binder in a range from 1.5 wt % to 5 wt %.

9. The cathode electrode of claim 1, wherein the second active material particles fill spaces between the first active material particles and greater than 90 wt % of the second active material particles are connected to clusters including the fibrillating binder and the conductive additive.

10. The cathode electrode of claim 1, wherein the fibrillating binder comprises polytetrafluoroethylene (PTFE).

11. The cathode electrode of claim 1, wherein the cathode active material layer has a D50 particle size in a range from 6 μm to 16 μm, a D90 particle size in a range from 20 μm to 30 μm, and a specific area in a range from 0.6 to 1.3 m²/g.

12. A method for manufacturing a cathode electrode for a battery cell, comprising:
a) creating a mixture by mixing a first cathode active material with a first particle size distribution, a second cathode active material having a second particle size distribution different than the first particle size distribution, and a conductive additive,
b) adding a fibrillating binder to the mixture;
c) using high shear force on the mixture to fibrillate the fibrillating binder;
d) calendaring the mixture to create a cathode active material layer; and
e) laminating the cathode active material layer onto a cathode current collector to form a cathode electrode.

13. The method of claim 12, wherein a) comprises:
a1) mixing the first cathode active material and the second cathode active material; and
a2) adding the conductive additive to the first cathode active material and the second cathode active material.

14. The method of claim 12, wherein a) comprises:
a1) mixing the first cathode active material with the conductive additive;
a2) mixing the second cathode active material with the conductive additive; and
a3) mixing the first cathode active material with the conductive additive and the second cathode active material with the conductive additive.

15. The method of claim 12, wherein:
the first secondary particle size distribution includes a D50 particle size in a range from 10 μm to 20 μm, and
the first secondary particle size distribution includes a D90 particle size in a range from 15 μm to 30 μm.

16. The method of claim 12, wherein the first cathode active material and the second cathode active material comprise secondary particles.

17. The method of claim 12, wherein the first cathode active material comprises secondary particles and the second cathode active material comprises single crystals.

18. The method of claim 15, wherein:
the second secondary particle size distribution includes a D50 particle size in a range from 2 μm to 8 μm, and
the second secondary particle size distribution includes a D90 particle size in a range from 5 μm to 10 μm.

19. The method of claim 12, wherein the second cathode active material comprises 5 wt % to 40 wt % of cathode active material in the cathode active material layer.

20. The method of claim 12, wherein:
the cathode active material layer comprises cathode active material in a range from 90 wt % to 96.5 wt %, the conductive additive in a range from 2 wt % to 5 wt %, and the fibrillating binder in a range from 1.5 wt % to 5 wt %, and
the cathode active material layer has a D50 particle size in a range from 6 μm to 16 μm, a D90 particle size in a range from 20 μm to 30 μm, and a specific area in a range from 0.6 to 1.3 m²/g.
